(19) United States
(12) Patent Application Publication
(10) Pub. No.: US 2024/0008433 A1
(43) Pub. Date: Jan. 11, 2024

(54) AEROPONIC SYSTEM WITH UNINTERRUPTED OPERATION AND ENERGY SAVING

(71) Applicant: CHIN WEN WU, New Taipei (TW)

(72) Inventor: CHIN WEN WU, New Taipei (TW)

(21) Appl. No.: 17/895,001

(22) Filed: Aug. 24, 2022

(30) Foreign Application Priority Data
Jul. 7, 2022 (TW) 111125627

(51) Int. Cl. A01G 31/00

(52) U.S. Cl. CPC A01G 31/00; A01G 2031/006

(57) ABSTRACT

An aeroponic system with uninterrupted operation and energy saving comprises a first nutrient solution storage tank, a second nutrient solution storage tank, a gas storage tank, an air compressor and a planting module; compresses air in the gas storage tank mainly through the air compressor, and transports a nutrient solution stored in the second nutrient solution storage tank to the planting module for watering by gas pressure, the excess nutrient solution dripped after watering is recycled to the first nutrient solution storage tank, and is finally transported back to the second nutrient solution storage tank to complete a circulating supply system. Since operation is carried out through a high-pressure gas stored in the gas storage tank, an object of uninterrupted operation and energy saving can be achieved.

### BACKGROUND OF THE INVENTION

### Field of Invention

The invention relates to an aeroponic system with uninterrupted operation and energy saving, and more particularly to a system capable of achieving nutrient supply without continuous power supply.

### Related Art

In the past, the conventional planting or farming methods required a large amount of manpower, time and area. Therefore, in recent years, many companies have adopted the so-called automated methods for planting or farming, with related equipment for automatically performing watering and fertilization, a large amount of manpower and time is saved. However, although automatic planting and farming have become a trend, in order to maintain the best environmental conditions, related equipment for watering and fertilization has to operate continuously with uninterrupted electric power, the long-term electricity cost is considerable, if watering and fertilization are interrupted, it is more likely to cause slow growth or death of plants.

Furthermore, the water and fertilizer liquid used for watering and fertilizing are not completely sprayed on the plants, and a certain proportion will fall to the soil or be scattered in other areas, thus causing considerable amount of waste.

Therefore, how to improve the drawbacks and tackle the problems mentioned above is the technical difficulty that the inventor of the invention wants to solve.

### SUMMARY OF THE INVENTION

Therefore, in order to effectively solve the above problems, a main object of the invention is to provide an aeroponic system with uninterrupted operation and energy saving, and more particularly to a system capable of achieving nutrient supply without continuous power supply.

Another object of the invention is to provide an aeroponic system capable of recovering nutrients.

In order to achieve the above objects, the invention provides an aeroponic system with uninterrupted operation and energy saving comprising: a first nutrient solution storage tank, a nutrient solution inlet is disposed on the first nutrient solution storage tank, the nutrient solution inlet is connected with a recovery pipeline, the first nutrient solution storage tank is provided with a feeding pipeline, the feeding pipeline is provided with a feeding valve thereon; a second nutrient solution storage tank connected with the feeding pipeline, the second nutrient solution storage tank is provided with an air inlet valve and a liquid outlet pipeline thereon, a control valve is disposed on the liquid outlet pipeline; a gas storage tank connected to the air inlet valve of the second nutrient solution storage tank; an air compressor connected to the gas storage tank; and a planting module connected to the recovery pipeline of the first nutrient solution storage tank and the liquid outlet pipeline of the second nutrient solution storage tank.

According to one embodiment of the invention, wherein a filter is further provided at the nutrient solution inlet of the first nutrient solution storage tank.

According to one embodiment of the invention, wherein the first nutrient solution storage tank is further provided with a liquid level detector and an acid-base sensor thereon.

According to one embodiment of the invention, wherein a disposing position of the first nutrient solution storage tank is higher than a disposing position of the second nutrient solution storage tank.

According to one embodiment of the invention, wherein a pressure relief valve is further provided on the second nutrient solution storage tank.

According to one embodiment of the invention, wherein an air pressure detector is further provided when the gas storage tank and the air inlet valve of the second nutrient solution storage tank are connected to each other.

According to one embodiment of the invention, wherein the planting module comprises a rack body; a receiving body disposed below the rack body, at least one shielding body is further disposed on sides of the rack body; at least one sprinkler disposed on a lower part of the rack body and above the receiving body, the sprinkler is connected with the liquid outlet pipeline; and a plurality of planting pots disposed on the rack body, and the planting pots are respectively provided with at least one through hole.

According to one embodiment of the invention, wherein the rack body is further provided with at least one carbon dioxide supplier, at least one lighting device, at least one air intake and exhaust device, and at least one temperature and humidity sensor.

According to one embodiment of the invention, wherein further comprising a monitoring module connected to the carbon dioxide supplier, the lighting device, the air intake and exhaust device, the temperature and humidity sensor, the liquid level detector, the acid-base sensor, the feeding valve, the control valve, the pressure relief valve and the air pressure detector.

According to one embodiment of the invention, wherein the receiving body and the shielding body are designed to be assembled to and detached from the rack body.

According to one embodiment of the invention, wherein the receiving body comprises at least one lower corresponding component, the shielding body comprises at least one upper corresponding component, and the rack body comprises at least one quick-release component.

### BRIEF DESCRIPTION OF THE DRAWINGS

FIG. 1 is a structural schematic diagram of a system of the invention.

FIG. 2 is a schematic diagram of a system embodiment of the invention.

FIG. 3 is a second schematic diagram of a system embodiment of the invention.

FIG. 4 is a structural schematic diagram of a planting module of the invention.

FIG. 5 is a schematic diagram of an embodiment of the planting module of the invention.

FIG. 6 is a second schematic diagram of an embodiment of the planting module of the invention.

FIG. 7 is a schematic diagram of a further embodiment of the invention.

### DETAILED DESCRIPTION OF THE INVENTION

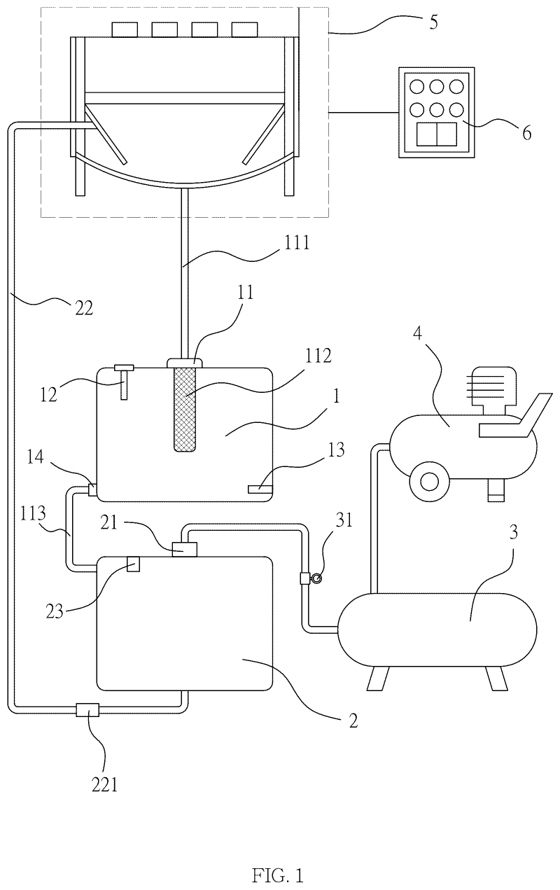

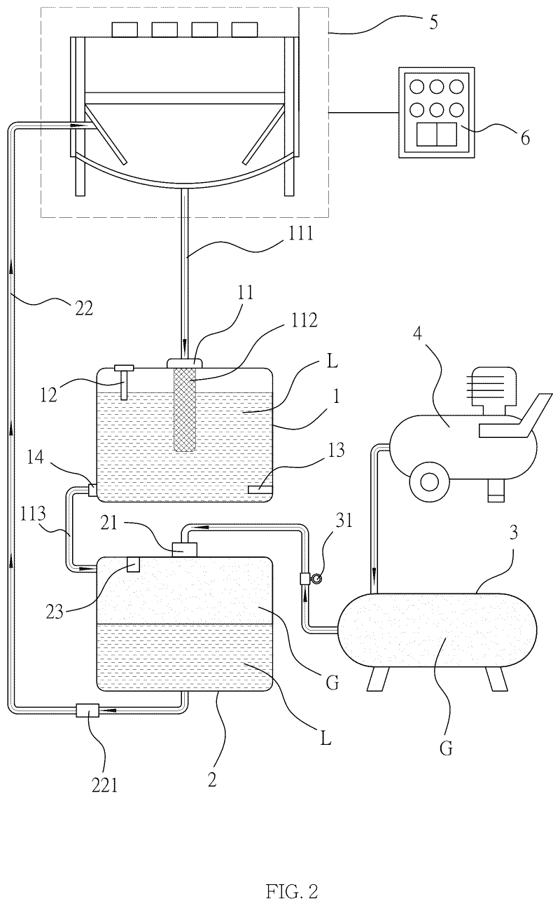

Please refer to FIG. 1 and FIG. 2. It can be clearly seen from the figures that an aeroponic system with uninterrupted operation and energy saving of the invention comprises the following.

A first nutrient solution storage tank 1, a nutrient solution inlet 11 is disposed on the first nutrient solution storage tank 1, the nutrient solution inlet 11 is connected with a recovery pipeline 111, the first nutrient solution storage tank 1 is provided with a feeding pipeline 113, the feeding pipeline 113 is provided with a feeding valve 14 thereon; a second nutrient solution storage tank 2 connected to the feeding pipeline 113, an air inlet valve 21 and a liquid outlet pipeline 22 are provided on the second nutrient solution storage tank 2, a control valve 221 is disposed on the liquid outlet pipeline 22; a gas storage tank 3 connected to the air inlet valve 21 of the second nutrient solution storage tank 2; an air compressor 4 connected to the gas storage tanks 3; and a planting module 5 connected to the recovery pipeline 111 of the first nutrient solution storage tank 1 and the liquid outlet pipeline 22 of the second nutrient solution storage tank 2, wherein the second nutrient solution storage tank 2 can be a pressure container, such as a high-pressure tank, etc., which stores a high-pressure gas G and a nutrient solution L, the control valve 221 can be a general mechanical valve or an electronic valve. When the planting module 5 needs the nutrient solution L, the control valve 221 is opened, the high-pressure gas G in the second nutrient solution storage tank 2 pushes the nutrient solution L through the liquid outlet pipeline 22 to the planting module 5. Therefore, the invention relies on gas pressure to deliver the nutrient solution L and is different from the prior art which mainly drives a motor or a pump by electricity, and the invention is capable of saving energy. In addition, after the nutrient solution L is used, the excess nutrient solution L of the planting module 5 can be recovered to the first nutrient solution storage tank 1 through the recovery pipeline 111, so that the nutrient solution L can be recycled and reused to reduce a waste of the nutrient solution L.

In addition, the gas storage tank 3 can be a pressure container for storing the high-pressure gas G compressed by the air compressor 4. When air pressure in the second nutrient solution storage tank 2 is insufficient, the nutrient solution L cannot be pushed to the planting module 5, at this time, the high-pressure gas G of the gas storage tank 3 can be supplemented to the second nutrient solution storage tank 2 by opening the air inlet valve 21, so that the high-pressure gas G in the second nutrient solution storage tank 2 can maintain a high-pressure state. In a state of provided with power supply, the air compressor 4 can be used to store a large amount of the high-pressure gas G in the gas storage tank 3. When power is turned off, the high-pressure gas G stored in the gas storage tank 3 in advance can be used to maintain operation of the system in order to keep supplying the nutrient solution L uninterruptedly and to avoid slow growth or death of plants.

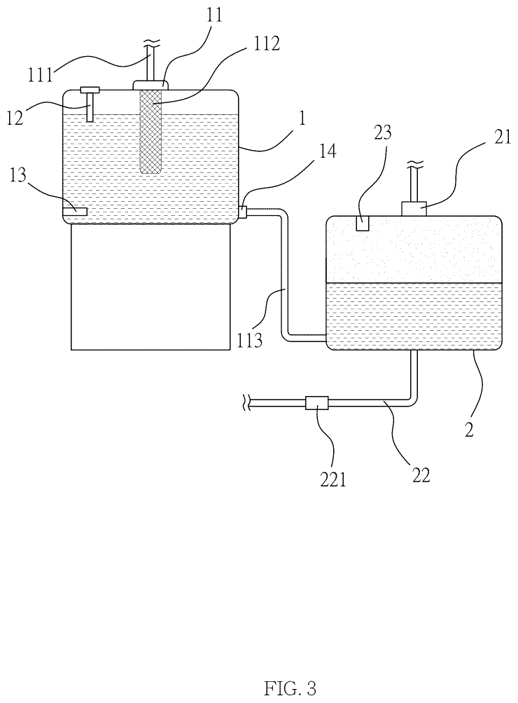

Please refer to FIG. 1, FIG. 2 and FIG. 3. A filter 112 is further provided at the nutrient solution inlet 11 of the first nutrient solution storage tank 1, and a liquid level detector 12 and an acid-base sensor 13 are further disposed on the first nutrient solution storage tank 1. A disposing position of the first nutrient solution storage tank 1 is higher than a disposing position of the second nutrient solution storage tank 2. A pressure relief valve 23 is further provided on the second nutrient solution storage tank 2. When the gas storage tank 3 and the air inlet valve 21 of the second nutrient solution storage tank 2 are connected to each other, an air pressure detector 31 is further provided, wherein the nutrient solution L can be added or the nutrient solution L can be recovered to the first nutrient solution storage tank 1 through the nutrient solution inlet 11 of the first nutrient solution storage tank 1, when the nutrient solution L of the second nutrient solution storage tank 2 decreases, the pressure relief valve 23 on the second nutrient solution storage tank 2 can be opened to release a pressure in the second nutrient solution storage tank 2, and then the feeding valve 14 is opened, at this moment, the nutrient solution L will be replenished from the first nutrient solution storage tank 1 to the second nutrient solution storage tank 2 through the feeding pipeline 113 to complete replenishment of the nutrient solution L. Further, with a disposing position of the first nutrient solution storage tank 1 being higher than a disposing position of the second nutrient solution storage tank 2, the nutrient solution L can be transported to the second nutrient solution storage tank 2 by a pressure difference generated by a difference in height, and therefore other power-consuming equipment such as motors and pumps are not required to assist transportation to achieve an efficacy saving energy. In addition, the air pressure detector 31 installed between the gas storage tank 3 and the air inlet valve 21 of the second nutrient solution storage tank 2 is mainly used to detect an air pressure in the second nutrient solution storage tank 2, if the air pressure is insufficient, the air compressor 4 is activated to drive air into the high-pressure gas G in the gas storage tank 3.

In addition, the liquid level detector 12 and the acid-base sensor 13 are further disposed on the first nutrient solution storage tank 1. The acid-base sensor 13 is used to monitor a pH value of the nutrient solution L, thereby adjusting an acid-base concentration of the nutrient solution L timely to ensure that the nutrient solution L is not deteriorated. The liquid level detector 12 is used to detect a stored amount of the nutrient solution L in the first nutrient solution storage tank 1. When a stored amount of the nutrient solution L is insufficient, the nutrient solution L is added to ensure that the first nutrient solution storage tank 1 has enough nutrient solution L to supply to the second nutrient solution storage tank 2, and a stored amount of the nutrient solution L in the second nutrient solution storage tank 2 can be roughly known by an amount of the nutrient solution L stored in the first nutrient solution storage tank 1. Finally, when the newly added nutrient solution L or the recovered nutrient solution L enters the first nutrient solution storage tank 1, impurities in the nutrient solution L can be filtered through the filter 112 to maintain a quality of the nutrient solution L.

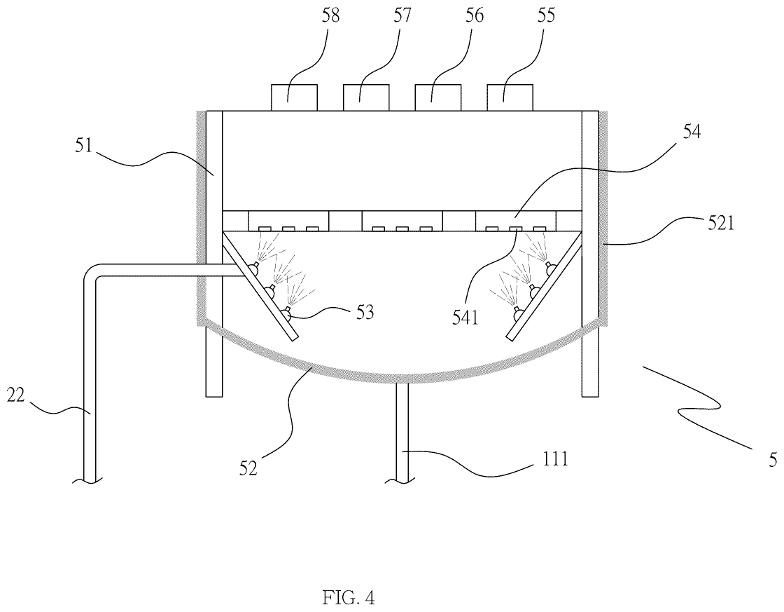

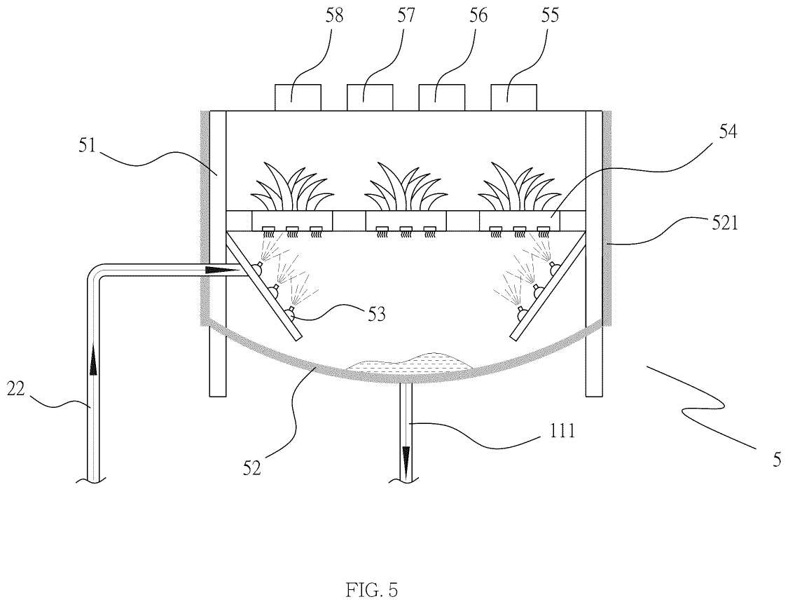

Please refer to FIG. 4 and FIG. 5, wherein the planting module 5 comprises: a rack body 51; a receiving body 52 disposed below the rack body 51, at least one shielding body 521 is further disposed on sides of the rack body 51, the receiving body 52 is connected to the recovery pipeline 111 of the first nutrient solution storage tank 1; at least one sprinkler 53 disposed on a lower part of the rack body 51 and above the receiving body 52, an angle of the sprinkler 53 can be adjusted, the sprinkler 53 is connected with the liquid outlet pipeline 22; and a plurality of planting pots 54 disposed on the rack body 51, and the planting pots 54 are respectively provided with at least one through hole 541; wherein the sprinkler 53 receives the nutrient solution L transported from the liquid outlet pipeline 22, and sprays the nutrient solution L on bottoms of the planting pots 54 to water roots of plants. After spraying by the sprinkler 53, the excess or dripped nutrient solution L will fall to the receiving body 52 disposed below the rack body 51, and the nutrient solution L is recovered to the first nutrient solution storage tank 1 through the recovery pipeline 111 connected with the receiving body 52, thereby effectively reducing a waste of the nutrient solution L.

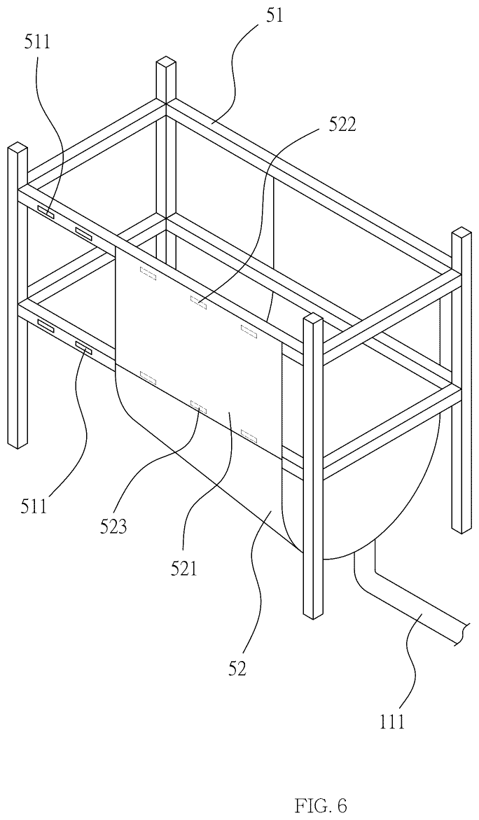

Please refer to FIG. 4, FIG. 5 and FIG. 6, the receiving body 52 is made of waterproof and flexible material, such as waterproof canvas, etc., and the receiving body 52 can be inclined so that a height of one end of the receiving body 52 close to the liquid outlet pipeline 22 is lower than a height of another end of the receiving body 52 away from the liquid outlet pipeline 22, thereby it is more conducive for the nutrient solution L to flow toward the recovery pipeline 111 for recovery. Furthermore, the at least one through hole 541 is respectively provided on the planting pots 54 of the planting module 5, which is mainly used to enable a plant to be inserted into the through hole 54 after being placed on a sponge, so that roots of the plant are located under the planting pot 54, and the nutrient solution L sprayed by the sprinkler 53 can be sprayed to reach the roots of the plants. A spraying angle of the sprinkler 53 can also be adjusted according to growth conditions of the plant roots to make spraying more precise.

In addition, the at least one shielding body 521 is further disposed on sides of the rack body 51, in addition to being mainly used to block the sprinkler 53 from spraying the nutrient solution L outside of the rack body 51 to avoid waste, the shielding body 521 can also be used to shield light from irradiating the roots of the plants. The receiving body 52 and the shielding body 521 are designed to be assembled on and disassembled from the rack body 51. For example, at least one quick-release component 511 can be provided on the rack body 51, at least one lower corresponding component 523 and at least one upper corresponding component 522 can be provided on the receiving body 52 and the shielding body 521 respectively, the quick-release component 511, the upper corresponding component 522 and the lower corresponding component 523 can be components that are easy to disassemble such as double-sided tape, Velcro, hook and hanging hole, etc., thereby the receiving body 52 and the shielding body 521 can be easily removed in order to clean, repair or replace the liquid outlet pipeline 22, the rack body 51, the sprinkler 53, the receiving body 52, and the shielding body 521.

Wherein the rack body 51 is further provided with at least one carbon dioxide supplier 55, at least one lighting device 56, at least one air intake and exhaust device 57, and at least one temperature and humidity sensor 58, wherein the carbon dioxide supplier 55 and the lighting device 56 supply carbon dioxide and light required by the plants, the temperature and humidity sensor 58 senses a current ambient temperature, and the air intake and exhaust device 57 can be a fan or an air conditioner to control air flow and to adjust temperature.

A monitoring module 6 is connected to the carbon dioxide supplier 55, the lighting device 56, the intake and exhaust device 57, the temperature and humidity sensor 58, the liquid level detector 12, the acid-base sensor 13, the feeding valve 14, the control valve 221, the pressure relief valve 23 and the air pressure detector 31, wherein the monitoring module 6 can be a central processing system, a computer, a handheld device or a control panel, which can be connected to the above components by electrical connection or wireless signal connection for monitoring states of the above components.

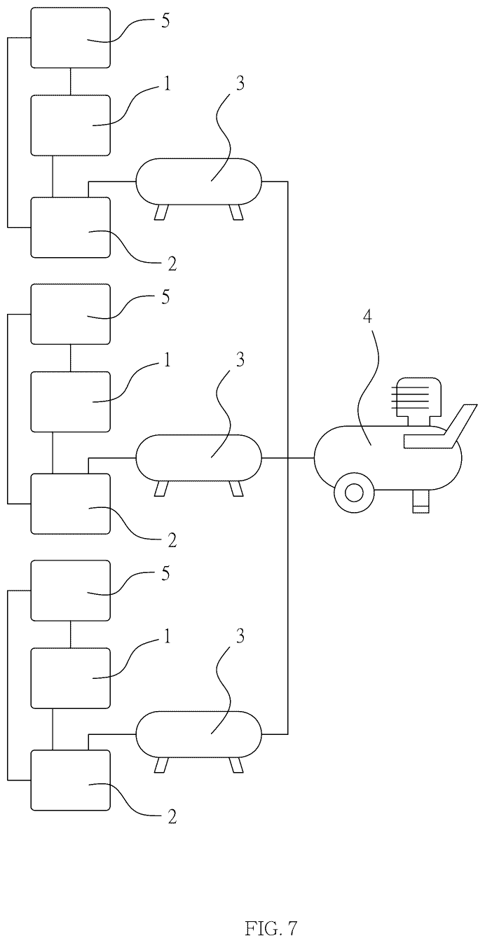

In addition, as shown in FIG. 7, which is a further embodied mode of the invention, since the air compressor 4 does not need to maintain operation of continuously supplying air pressure, the single air compressor 4 can be used to provide the high-pressure gas G required by the gas storage tanks 3.

In summary, compared with the prior art using related equipment for automatically performing watering and fertilization which causes various drawbacks and problems that cannot be solved, through the special design of the first nutrient solution storage tank 1, the second nutrient solution storage tank 2, the gas storage tank 3, the air compressor 4 and the planting module 5 in the invention, the air compressor 4 is required to operate only when an air pressure of the gas storage tank 3 is insufficient, which greatly reduces the cost of power consumption. Furthermore, with the high-pressure gas G being stored in the gas storage tank 3, the aeroponic system with uninterrupted operation and energy saving of the invention is capable of operating without interruption. Finally, through the recovery and circulation mechanism of the sprayed nutrient solution L provided by the first nutrient solution storage tank 1 and the second nutrient solution storage tank 2 for the planting module 5, waste of the nutrient solution L can be effectively reduced.

It is to be understood that the above description is only preferred embodiments of the invention and is not used to limit the invention, and changes in accordance with the concepts of the invention may be made without departing from the spirit of the invention, for example, the equivalent effects produced by various transformations, variations, modifications and applications made to the configurations or arrangements shall still fall within the scope covered by the appended claims of the invention.

What is claimed is:

1. An aeroponic system with uninterrupted operation and energy saving comprising:
a first nutrient solution storage tank, a nutrient solution inlet being disposed on the first nutrient solution storage tank, the nutrient solution inlet being connected with a recovery pipeline, the first nutrient solution storage tank being provided with a feeding pipeline, the feeding pipeline being provided with a feeding valve thereon;
a second nutrient solution storage tank connected with the feeding pipeline, the second nutrient solution storage tank being provided with an air inlet valve and a liquid outlet pipeline thereon, a control valve being disposed on the liquid outlet pipeline;
a gas storage tank connected to the air inlet valve of the second nutrient solution storage tank;
an air compressor connected to the gas storage tank; and
a planting module connected to the recovery pipeline of the first nutrient solution storage tank and the liquid outlet pipeline of the second nutrient solution storage tank.

2. The aeroponic system with uninterrupted operation and energy saving as claimed in claim 1, wherein a filter is further provided at the nutrient solution inlet of the first nutrient solution storage tank.

3. The aeroponic system with uninterrupted operation and energy saving as claimed in claim 1, wherein the first nutrient solution storage tank is further provided with a liquid level detector and an acid-base sensor thereon.

4. The aeroponic system with uninterrupted operation and energy saving as claimed in claim 1, wherein a disposing position of the first nutrient solution storage tank is higher than a disposing position of the second nutrient solution storage tank.

5. The aeroponic system with uninterrupted operation and energy saving as claimed in claim 1, wherein a pressure relief valve is further provided on the second nutrient solution storage tank.

6. The aeroponic system with uninterrupted operation and energy saving as claimed in claim 1, wherein an air pressure detector is further provided when the gas storage tank and the air inlet valve of the second nutrient solution storage tank are connected to each other.

7. The aeroponic system with uninterrupted operation and energy saving as claimed in claim 1, wherein the planting module comprises;
a rack body;
a receiving body disposed below the rack body, at least one shielding body is further disposed on sides of the rack body;
at least one sprinkler disposed on a lower part of the rack body and above the receiving body, the sprinkler is connected with the liquid outlet pipeline; and
a plurality of planting pots disposed on the rack body, and the planting pots are respectively provided with at least one through hole.

8. The aeroponic system with uninterrupted operation and energy saving as claimed in claim 7, wherein the rack body is further provided with at least one carbon dioxide supplier, at least one lighting device, at least one air intake and exhaust device, and at least one temperature and humidity sensor.

9. The aeroponic system with uninterrupted operation and energy saving as claimed in claim 8, wherein further comprising a monitoring module connected to the carbon dioxide supplier, the lighting device, the air intake and exhaust device, the temperature and humidity sensor, the liquid level detector, the acid-base sensor, the feeding valve, the control valve, the pressure relief valve and the air pressure detector.

10. The aeroponic system with uninterrupted operation and energy saving as claimed in claim 7, wherein the receiving body and the shielding body are designed to be assembled to and detached from the rack body.

11. The aeroponic system with uninterrupted operation and energy saving as claimed in claim 7, wherein the receiving body comprises at least one lower corresponding component, the shielding body comprises at least one upper corresponding component, and the rack body comprises at least one quick-release component.
